(19) United States
(12) Patent Application Publication
(10) Pub. No.: US 2024/0101196 A1
(43) Pub. Date: Mar. 28, 2024

(54) WHEEL ARCH WITH OPTIMIZED WHEEL ARCH LINING

(71) Applicant: AUTONEUM MANAGEMENT AG, Winterthur (CH)

(72) Inventors: Johan GRÉBERT, Schlatt (CH); David SIMON, Guyancourt (FR); Pascaline BRÉGEON, Ivry La Bataille (FR); Laetitia LANGRENAY, Morainvilliers (FR)

(73) Assignee: AUTONEUM MANAGEMENT AG, Winterthur (CH)

(21) Appl. No.: 18/548,920

(22) PCT Filed: Mar. 9, 2023
(86) PCT No.: PCT/EP2022/055976

§ 371 Date: Sep. 4, 2023

(30) Foreign Application Priority Data
Mar. 10, 2021 (DE) 10 2021 202 349.5

(51) Int. Cl. B62D 25/16; B32B 3/08; B32B 3/26; B32B 5/02; B32B 27/12; B32B 37/06; B60R 13/08; B62D 25/18

(52) U.S. Cl. CPC B62D 25/161; B32B 3/085; B32B 3/263; B32B 5/022; B32B 27/12; B32B 37/06; B60R 13/0815; B60R 13/0861; B62D 25/18; B32B 2262/0284; B32B 2262/124; B32B 2305/18; B32B 2307/102; B32B 2307/546; B32B 2307/718; B32B 2307/722; B32B 2307/724; B32B 2307/7376; B32B 2309/12; B32B 2605/00

(57) ABSTRACT

Wheel arch for a motor vehicle with a wheel arch housing component for at least partially delimiting the wheel arch for a vehicle wheel of the motor vehicle, and with a wheel arch lining which is arranged on the surface of the wheel arch housing component facing the wheel and extends at least partially along this surface, the wheel arch lining having at least one support layer and one fiber layer, wherein the support layer forms the outer side of the wheel arch lining facing the wheel and the fiber layer is arranged between the wheel arch housing component and the support layer and the support layer and the fiber layer are thermally bonded to one another and formed into a wheel arch lining and wherein at least 50%, preferably at least 65%, preferably at least 80% of the surface of the fiber layer is in contact with the wheel arch housing component.

### TECHNICAL FIELD

The present invention relates to a wheel arch (1) with a wheel arch housing component (7) and an optimized wheel arch lining (4, 5, 6).

### STATE OF THE ART

In a motor vehicle, a wheel arch, also known as a wheel case or wheel housing, at least partially delimits a receiving area for a vehicle wheel of the motor vehicle. The wheel arch is usually formed by a recess in the vehicle body. In addition to the passage for the wheel axle, it has several additional openings in the wheel arch for sensors, cables or fasteners. The wheel arch may contain a wheel arch lining.

It is well known that in addition to noise from a vehicle engine of the motor vehicle, rolling noise from the vehicle tires is also a major source of noise in road traffic. In order to contain the noise generated, it is common practice to provide a wheel arch between the body and the wheel, which is capable of reducing this noise both with regard to the driver's cab and the surrounding area.

Such a wheel installation, referred to there as a wheel arch (10), with a wheel arch housing component (12) for delimiting the wheel arch (10) is described in DE102018128163. The wheel arch housing component (12) described there has a sound-absorbing damping device (20), corresponding to a wheel arch lining, which in turn provides a sound-permeable, perforated and/or membrane-like protective device (22) on its outer side, i.e. the side facing the wheel. The primary function of the protective device (22) there is to prevent the penetration of a foreign body material through the protective device (22).

There is a notion in the industry today that an air gap is needed between such a damping device and the wheel arch housing component to minimize noise at an annoying sound frequency, and to prevent rocks or debris from being trapped between the wheel arch and the wheel arch lining.

EP1902904 describes a sound attenuating component fora structure delimiting an air space (18, 26) between an external element (20, 34) and a rigid structural member (10, 24), the component comprising a substantially hermetic layer and a sound attenuating complex (12, 28, 30) disposed between the rigid structural member (10, 24) and the substantially hermetic layer, the sound attenuating complex (12, 28, 30) being formed by at least two layers (14, 16; 28, 30), the air space (18, 26) remaining between the sound-absorbing complex (12) and a member chosen between the external element (20, 34) and the rigid structural member (10, 24) having a thickness greater than 2 cm.

However, the combination of the air gap and the openings in the body is detrimental to noise pollution in the passenger compartment of the vehicle. Rolling noise is only partially absorbed or reduced by the wheel arch linings and can still reach the passenger compartment via the air gap and openings in the body.

Internal studies have shown that rolling noise and driving noise are perceived as particularly annoying, especially in the rear seats. But the requirements for reducing road traffic noise for the surrounding area are also becoming increasingly stringent and call for an alternative wheel arch lining that reduces driving noise both outside and inside the vehicle.

Another problem with today's wheel arch linings is their complex structure, which necessitates a multi-stage production method due to the large number of layers. This results from the fact that the production technologies are subject to the typical cycle times of the automotive industry. To ensure this, the various layers are built up one after the other in individual method steps.

The wheel arch itself is a complex structure which, due to its proximity to moving parts, requires a high degree of fitting accuracy of the trim part and places the highest demands on the use of the available installation space. Special attention must be paid to the fact that this installation space is often very unevenly shaped due to various functional attachments and has a geometrically complex structure. For this reason, it is customary not to make ideal use of the installation space and an unevenly pronounced air gap is accepted between the wheel arch and the wheel arch lining. Even though a remaining air gap reduces the complexity of the cladding component, it nevertheless reduces the effectiveness of noise reduction.

### SUMMARY OF THE INVENTION

It is therefore the task of the present invention to provide an alternative wheel arch lining (4, 5, 6) or a wheel arch (1) with such a lining, which reduces noise both in the passenger compartment and in the external environment of the motor vehicle. Furthermore, a method for manufacturing such a wheel arch lining (4, 5, 6) is provided.

This task is solved by the subject-matter of the independent patent claim. Advantageous further embodiments of the invention are disclosed by the features of the dependent patent claims, the following description and the figures.

The wheel arch (1) according to the present invention comprise a wheel arch housing component (7) and a wheel arch lining (4, 5, 6) which together reduce noise emission both inside the vehicle interior and outside the vehicle. The wheel arch lining (4, 5, 6) comprise at least one fibrous support layer (4) and one fibrous layer (6). Preferably, a third layer (5) in the form of a film or adhesive layer is arranged between the fibrous support layer (4) and the fiber layer (6).

In particular, the present invention relates to a wheel arch (1) for a motor vehicle with a wheel arch housing component (7) for at least partially delimiting the wheel arch (1) for a vehicle wheel of the motor vehicle, and with a wheel arch lining (4, 5, 6) which is arranged on the surface of the wheel arch housing component (7) facing the wheel and extends at least partially along this surface, the wheel arch lining (4, 5, 6) comprises at least one support layer (4) and a fiber layer (6), the support layer (4) forming the outer side of the wheel arch lining (4, 5, 6) facing the wheel and the fiber layer (6) being arranged between the wheel arch housing component (7) and the support layer (4), and the support layer (4) and the fiber layer (6) being thermally bonded to one another and formed into a wheel arch lining (4, 5, 6) and wherein at least 50%, preferably at least 65%, preferably at least 80% of the surface of the fiber layer (6) is in contact with the wheel arch housing component (7).

Here, in the context of the invention, the term “contact” means that there is a frictional connection between the two layers or components in question.

In a preferred embodiment, a third layer (5) is arranged between the support layer (4) and the fiber layer (6), which is designed as a film or adhesive layer. This third layer (5) improves the thermal bonding of the layers within the wheel arch lining (4, 5, 6) and can additionally positively influence the acoustic properties because it allows the airflow resistance to be adjusted to a target value.

In a further preferred embodiment, the fiber layer (6) has a protective layer, e.g. a thin nonwoven fabric or a thin textile layer, on the surface facing the wheel arch housing component (7). The thickness of the protective layer is preferably 1 mm or less. This protective layer at least partially spans the fiber layer (6) and has the function of protecting the surface facing the body. The provision of an additional protective layer is particularly advantageous in the areas where the wheel arch housing component (7) has openings.

The wheel arch lining (4, 5, 6) is produced by a thermal forming process. In this process, all layers (support layer (4), optional third layer (5), fiber layer (6) and optional protective layer) of the wheel arch lining (4, 5, 6) are bonded together and formed in a press mold.

### DETAILED DESCRIPTION OF THE INVENTION

The wheel arch housing component (7)

The wheel arch (1) for a motor vehicle according to the invention comprises a wheel arch housing component (7). This is designed to at least partially delimit the wheel arch (1). In its function as a component of the wheel arch (1), the wheel arch housing component (7) at least partially delimits a receiving area of a vehicle wheel of the motor vehicle. The wheel arch housing component (7) as a component of the wheel arch (1) can form a partial area of a vehicle body or represent an independent part which is connected to the vehicle body. The wheel arch housing component (7) may further be directly adjacent to a fender of the motor vehicle.

The wheel arch housing component (7) can be formed from a metallic or non-metallic material. In addition, the wheel arch housing component (7) can contain a sound-absorbing layer, preferably a sprayed-on plastic or damping layer either on the side facing the wheel or on the side facing away from the wheel.

The wheel arch lining (4, 5, 6)

The wheel arch lining (4, 5, 6) comprises a support layer (4), a fiber layer (6) and preferably a further, third layer (5) arranged between the support layer (4) and the fiber layer (6). The layers (4) and (6) as well as the optional layer (5) are materially bonded to each other.

The support layer (4) preferably contains a fiber mixture comprising binder fibers. Preferably, two-component fibers, e.g. fibers with a co-polyester sheath and a polyester core, or polypropylene fibers are used as binder fibers. For example, the support layer (4) is made from a mixture of two-component binder fibers and polyester short fibers. The proportion of binder fibers in the fiber blend is preferably in the range of 25 to 50% by weight.

During thermal forming of the layers, the binder fibers or the binder fiber parts with the lowest melting temperature are melted and the remaining fibers are bonded together to form a material bond between the fibers and also between the layers. After forming, the support layer is inherently rigid and forms the outer layer of the wheel arch lining (4, 5, 6). The outer surface, facing away from the wheel arch, faces the tire in the assembled state.

Preferably, the support layer (4) is in the form of a compacted fiber mat. In this case, the fiber mat is made from fibers, preferably two-component continuous filaments, by e.g. carding, crosslapping and/or needling, and compacted as a result of the process. In addition, thermal pre-consolidation can take place after needling. The compaction as well as the consolidation of the support layer (4) results in a robust surface against dirt and water as well as resistance against stone chipping, while the layer is still open-pored enough for noise absorption.

Preferably, the support layer (4) comprises a basis weight of 600 g/m² to 1400 g/m², particularly preferably not above 1200² g/m and further preferably not above/above 800 g/m². Preferably, the support layer (4), preferably designed as a fiber mat, comprises a constant thickness and a constant basis weight. However, depending on the spatial requirements of the vehicle, the support layer (4) can also comprise a constant weight per unit area but different thicknesses, or different thicknesses with different weights per unit area. This can be adjusted by corresponding variation of the forming process. Preferably, the thickness is 1 mm to 7 mm, more preferably 3 mm to 5 mm.

The fiber layer (6) comprises a lower density and stiffness compared with the support layer (4). Preferably, an air-laid fiber mat with a fiber mixture of matrix and binder fibers is used. The fiber layer (6) substantially fills the space existing between the support layer (4) and the wheel arch housing component (7). At least 50% or more, preferably at least 65%, preferably at least 80% of the surface area of the fiber layer (6) is in contact with the surface of the wheel arch housing component (7) facing the fiber layer (6).

In a preferred embodiment, the fiber layer (6) contains a matrix fiber blend with a proportion of self-crimping fibers. Preferably, this proportion is 10 to 70% by weight of the fibers. A further preferred mixture of fibers for the fiber layer (6) is composed of 10 to 40% by weight of binder fibers, 10 to 70% of recycled fibers and/or 10 to 70% of self-crimping fibers, and wherein the total amount of fibers is 100% by weight. Self-crimping fibers and their production are known to the skilled person and are described, for example, in DE19517348 C1, DE19517350 C1. Such fibers are present, for example, in the form of a spiral, omega or helix.

In the side areas of the wheel arch lining (4, 5, 6), the fiber layer (6) is present in compressed form and is materially bonded to the support layer (4). This area of the wheel arch lining is frictionally bonded to the wheel arch housing component (7). The fiber layer (6) thus comprise a different thickness T, density and basis weight measured perpendicular to the surface of the support layer (4). Due to the very complex shape of the space between the wheel arch housing component (7) and the support layer (4), the fiber layer (6) must therefore be designed to be highly compressible. Naturally, this also contributes to the absorption of sound.

The maximum thickness T of the fiber layer (6) is preferably selected to provide an optimum compromise between noise absorption, weight and cost. In some areas, the distance between the surface of the support layer (4) facing the wheel arch housing component (7) and the wheel arch housing component (7) is 45 mm or more. Providing a fiber layer (6) with a thickness that completely fills this distance is not advantageous because, on the one hand, the space (8) between the support layer (4) and the wheel arch housing component (7) is virtually completely filled with fiber material, but this is accompanied by higher costs and weight due to higher material consumption. Therefore, the maximum thickness of the fiber layer (6) is preferably up to 35 mm, e.g. from 20 to 35 mmm, depending on the geometry of the space.

Indeed, if the thickness of the fiber layer (6) were to be further increased with the aim of completely filling the space, only a small improvement, if any, in the acoustic properties of the wheel arch lining (4, 5, 6) would be obtained, but at the same time this would entail an unnecessary increase in the cost and weight of the wheel arch lining (4, 5, 6) and thus of the wheel arch (1).

If the maximum distance between the support layer (4) and the wheel arch housing component (7) is less than 35 mm, preferably less than 27 mm, more preferably less than 20 mm, the fiber layer (6) is designed so that the space between the two surfaces of the support layer (4) and the wheel arch housing component (7) facing each other is 100% filled, i.e. the fiber layer (6) and the wheel arch housing component (7) are in contact with each other over their entire surface.

In areas where the maximum distance is greater than 35 mm, preferably greater than 27 mm, further preferably greater than 20 mm, this is not necessary for acoustic or other reasons and would merely increase the material consumption for the fiber layer (6), which would be associated with higher costs. In any case, the fiber layer (6) is designed in such a way that at least 50%, preferably at least 65%, preferably 80% of its surface, or the surface of the protective layer, if any, is in contact with the wheel arch housing component (7), i.e. the surface of the wheel arch housing component (7) facing the fiber layer (6).

Typically, a space (8) remains between the fiber layer (6) and the wheel arch housing component (7), namely in the area of the greatest distance between the wheel arch housing component (7) and the support layer (4). Since the air inside this space (8) is not connected to the air outside the component, the noise-reducing effect of the wheel arch lining (4, 5, 6) is maintained. The contact between the fiber layer (6) and the wheel arch housing component (7) over at least 50% of its surface causes the space to be sealed. In contrast, the wheel arches of the prior art always have a continuous gap between the wheel arch housing component and the wheel arch lining. Via this gap, noise leads directly to excitation of the wheel arch housing component (7), which in turn leads to an increase in noise pollution in the vehicle interior.

With regard to the components of the fiber layer (6), in principle the same starting materials can be used as for the support layer (4). Both fiber layers contain binder fibers and matrix fibers such as short fibers or continuous filament fibers. The fibers used may be of synthetic, mineral or natural origin, or a mixture of such fibers. The fibers may be newly produced fibers, or recycled or reused materials, or even newly produced fibers from reused base materials. Of course, mixtures of these fibers can also be used.

For the fiber layer (6), a fiber blend of polyester fibers is preferably used, for example a fiber blend with up to 45% two-component binder fibers. Preferably, the melting temperature of the binder fibers in the fiber layer (6) is higher than that of the support layer (4). Preferably, the melting temperature of the binder fibers of the fiber layer (6) is at least 175° C.

In a preferred embodiment, the fiber layer (6) can additionally contain up to 30% crimped fibers. These fibers increase the resilience of the fiber layer (6) and promote the springiness of the layer. Surprisingly, the combination of low density, the use of preferably polyester fibers, and optionally the incorporation of crimped fibers results in a highly absorbent fiber layer (6) that can be used to fill almost the entire air space between the support layer (4) and the wheel arch housing component (7). This arrangement contradicts the preconception among experts that to achieve good sound absorption in a wheel arch (1) there must always be an air gap.

Preferably, the matrix fibers comprise a linear density (grams per 10,000 meters) of between 4 and 10 dtex. In a further preferred embodiment, 4.4 dtex two-component binder fibers are used. Preferably, the matrix fibers and the binder fibers have a substantially equal linear density, which entails good, i.e. uniform, miscibility of the fibers.

Preferably, the fiber layer (6) comprise a basis weight of 400 g/m² to 1600 g/m², preferably 500 g/m² to g/m1200², particularly preferably between 600 and 1000 g/m². The optional third layer (5), which may be in the form of a film or adhesive layer, is arranged between the support layer (4) and the fiber layer (6).

### Third Layer (5)

Preferably, the film layer (5) is multilayered, in particular three-layered. In this three-layer arrangement, the outer layers have a binder function between the layers (4) and (6). In the single-layer configuration, one layer has such a binder function. The binder function is achieved in particular by the fact that the layer(s) provided for this purpose melt(s) during manufacture. In said three-layer design, the middle layer remains substantially intact during the manufacturing method and forms a closed barrier.

In a further embodiment, the film layer (5) is designed to form pores during the manufacturing process, in which case this layer has its own air resistance.

The third layer (5) is preferably formed in the form of a film or foil by a thermoplastic material, e.g. a homo- or copolymer. Further preferred is a thermoplastic material based on a polyester, polyamide, polyurethane or polyolefin, further preferred polypropylene or polyethylene. Such films are well known to the skilled person. Examples include films made of polyamide, polypropylene or based on polyester. When a multilayer film is used, the polymers used have different melting temperatures, such that at least one film layer melts and bonds the adjacent layers (4, 6) to one another. Preferably, the film layer (5) has pores throughout. This can be achieved, for example, by exposure to hot steam during the thermal forming process. In this embodiment, the foil layer (5) also contributes significantly to the noise-reducing effect of the wheel arch linings (4, 5, 6). As can be seen from the above, in the wheel arch (1) according to the invention, the support layer (4) and the fiber layer (6) are materially bonded to each other, preferably via the third layer (5).

By combining a support layer (4) with a higher air resistance, a film or foil with its own additional air resistance, and a fiber layer (6) that utilizes the optimum space, it is possible to produce a wheel arch lining (4, 5, 6) that comprise an optimized balance between sound insulation and sound absorption.

Surprisingly, the wheel arch lining (4, 5, 6) according to the present invention shows higher sound insulation than expected, while sound absorption is still present. Increased sound insulation and the basic elimination of the air gap result in the reduction of noise inside the vehicle, while the sound-absorbing wheel arch lining reduces noise outside the vehicle. Some of the rolling noise is even absorbed directly by the wheel arch linings (4, 5, 6).

The surface of the support layer (4) facing away from the wheel and the surface of the wheel arch housing component (7) facing in the direction of the wheel together form an air space which, as explained above, is predominantly filled by the fiber layer (6). The fiber layer (6) is bonded to the support layer (4), preferably by means of a film or adhesive layer (5).

The fiber layer (6) therefore comprise either a variable density and/or a variable basis weight. To achieve a variable basis weight, fiber injection processes are preferably used, such as described in EP264088, where fibers are deposited in a mold in the form of a fiber stream.

The minimum distance from the outside of the wheel arch lining (4, 5, 6) to the wheel is specified by the motor vehicle manufacturer, based on driving safety, especially in curves.

In a preferred embodiment, the thickness of the fiber layer (6) is such that the wheel arch lining (4, 5, 6) is frictionally bonded to the wheel arch housing component (7) over a large area (50% or more of the surface area of the wheel arch housing component (7). The thickness of the fiber layer (6) in the wheel arch lining (4, 5, 6) before assembly with the wheel arch housing component (7) is thus greater over large areas than the gap between the surface of the wheel arch housing component (7) facing the support layer (4) and the surface of the support layer (4) facing the wheel arch housing component (7) after assembly. In this area, the fiber layer (6) and the wheel arch housing component (7) are then friction-locked to each other, and the fiber layer (6) is present in a compressed state. This is particularly the case in the side area of the wheel arch (1), resulting in additional sealing against noise in the direction of the interior.

If necessary, suitable patches can be applied in the areas with openings on the surface to protect the material locally against abrasion. Alternatively, a fiber fleece or textile layer can be applied over the fiber layer.

The wheel arch lining (4, 5, 6) is preferably air permeable, preferably with an air resistance between 500 and 6000 Rayls, preferably with an air resistance between 1500 and 4000 Rayls.

### Wheel Arch Manufacturing Method (1)

The wheel arch lining (4, 5, 6) is generally formed such that when installed/attached to the wheel arch, substantially the entire surface of the wheel arch housing component (7) is in contact with the fiber layer (6) of the wheel arch lining (4, 5, 6), preferably at least 50% of the surface area of the fiber layer, preferably at least 65% of the surface area, preferably at least 80% of the surface area.

The fiber layer (6), the film (5) and the support layer (4) and an optionally present protective layer, are pressed together into the final shape in one step by means of compression molding, and all layers are bonded to each other with a material bond. In this process, the thickness of the fiber layer (6) in particular is adjusted according to the required three-dimensional shape corresponding to the complex space.

The invention further relates to a preferred method for producing a wheel arch lining (4, 5, 6) according to the invention with a support layer (4), a fiber layer (6), and a third layer (5), which is designed as a film or foil. In the process, the wheel arch lining (4, 5, 6) is formed in a single thermal forming step starting from the first fiber layer (6) present in a forming mold and a second layer (4) provided as a support layer (4) and the film layer (5) optionally arranged in between.

In one embodiment, the forming step comprises at least two substeps (b.1) and (b.2):
(b.1) exposure of the first fiber layer (6), the film layer (5) and the second layer (4) to water vapor through openings which are permeable to vapor and air and which are arranged in the wall of the molding tool facing the first fiber layer (6), the water vapor having a temperature and vapor wetness and a vapor pressure such that, on the one hand, the first fiber layer (6) solidifies to form a material bond and, on the other hand, the vapor pressure of the water vapor against the third layer (5) after passing through the fiber layer (6) is sufficient to compress the second fiber layer (4);
(b.2) exposure of the second layer (4) to water vapor through openings which are permeable to vapor and air and are arranged in the wall of the mold facing the second layer (4), the water vapor having such a temperature and vapor wetness and such a vapor pressure that the second layer (4) solidifies to form a material bond and the support layer (4) is formed.

In addition, the manufacturing method results in the third layer (5) being able to become permeable to air.

Preferably, the steam exposure is carried out at a pressure of up to 15 bar, more preferably from 1 to 12 bar, and in particular at 7 to 11 bar.

During the thermal forming method to produce the wheel arch lining (4, 5, 6), the layers (4, 5, 6) are materially bonded and the support layer (4) is compressed to form a flexurally rigid support layer (4). The compression of the support layer (4) produces a compressed layer on the surface of the wheel arch lining (4, 5, 6) facing the wheel, which is permeable to air. The wheel arch lining (4, 5, 6) is also dirt-repellent and therefore suitable for being fitted as a direct surface facing the wheel with a minimum safety clearance.

### BRIEF DESCRIPTION OF THE FIGURES

FIG. 1 shows schematically the structure of the wheel arch (1) according to the invention.

The wheel arch lining (4, 5, 6) comprises an inherently rigid support layer (4) with sound-absorbing properties. With its surface facing away from the wheel arch or toward the tire, the support layer (4) also provides protection against external mechanical influences, such as stone impact.

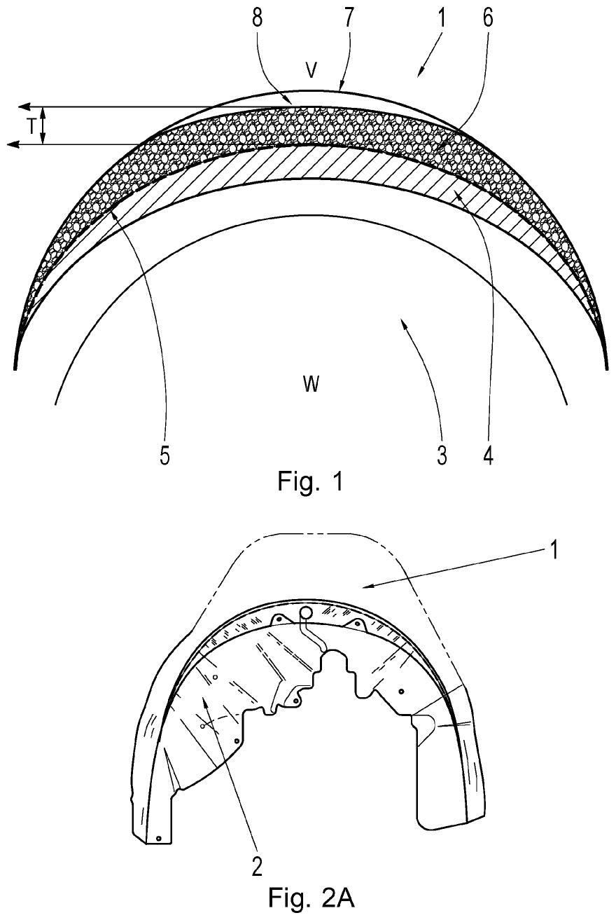

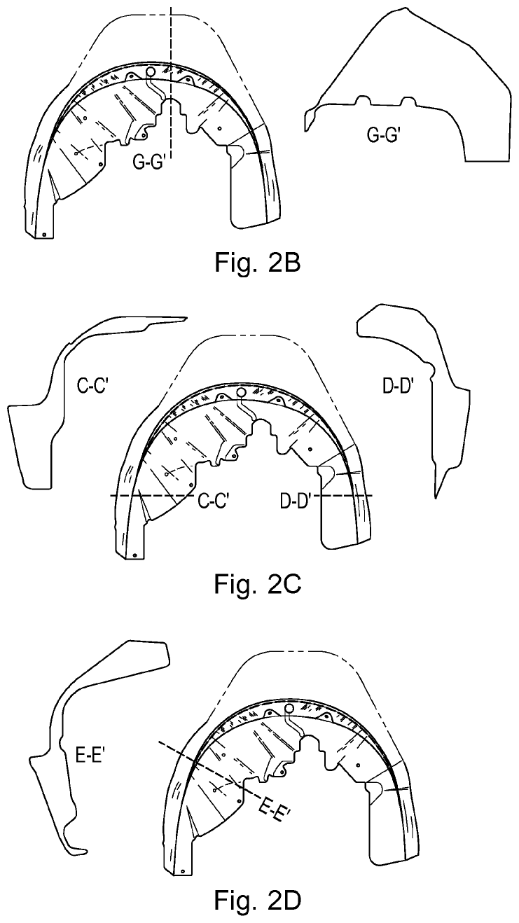

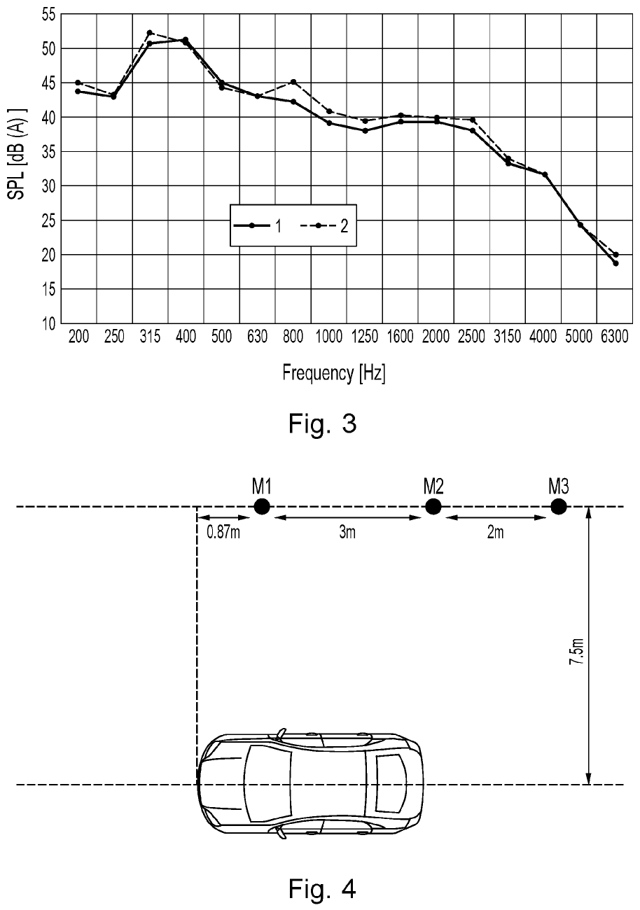

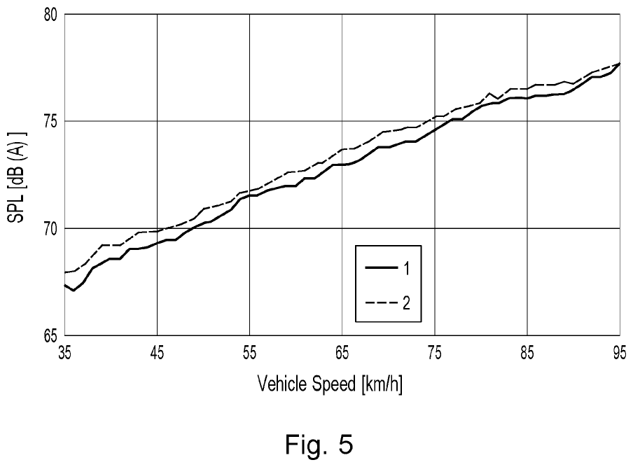

As can be seen from FIG. 1, a space exists between the wheel arch housing component (7) and the support layer (4) as part of the wheel arch lining (4, 5, 6). This space is predominantly filled by the fiber layer (6).

In a preferred embodiment, the wheel arch lining (4, 5, 6) comprises a third layer (5). This is arranged as a film or adhesive layer between the support layer (4) and the fiber layer (6).

FIGS. 2A to D show a wheel arch housing component (1) with a support layer 2. The inner surface (not visible) of the wheel arch housing component (7) and the surface of the support layer facing it together form a space which, as can be seen from FIGS. 2B to 2D, have a different geometry and a different cross-section.

The cross sections shown illustrate the complex distribution of space to which a wheel arch (1) must be adapted. Each vehicle has its own space limitations and requires an individual solution. The wheel arch (1) according to the invention should allow the available space to be fully utilized.

FIGS. 3 to 5 show results or the measurement setup (FIG. 4) of acoustic measurements on a state-of-the-art wheel arch compared with the wheel arch according to the invention, each mounted on the same SUV.

### EXAMPLE

Four wheel arch linings according to the invention were realized and installed on an off-road vehicle (hereinafter referred to simply as “SUV”) currently available for the European market, as a replacement for the standard wheel arch linings usually installed there, which were manufactured according to the specifications of the prior art. Acoustic tests were carried out to demonstrate, by objective measurements, the usefulness of the wheel arch liners according to the invention.

The wheel arch linings according to the invention consisted of a support layer (4), a fiber layer (6) and an air-permeable intermediate film (5) in between. The support layer (4) was made of a fiber blend consisting of 40% by weight PET/CoPET bicomponent binder fibers and 60% by weight PET short staple fibers. To give it sufficient stiffness, the support layer (4) was selected with a basis weight of around 800 g/m² and compacted to 3 mm. The intermediate film (5) consisted of an air-permeable film with a basis weight of 60 g/m². Finally, the fiber layer (6) consisted of 30% by weight of PET/CoPET bicomponent binder fibers, 30% by weight of self-crimped PET fibers, and 40% by weight of PET short recycled fibers. The basis weight of the fiber layer (6) was approximately constant over the area and was about 550 g/m². This low basis weight, together with the use of self-crimped fibers, makes the fiber layer (6) particularly soft and elastic.

In each of the four wheel arch linings according to the invention, the fiber layer (6) was shaped three-dimensionally to fill the space between the support layer (4) and the SUV wheel arch housing component (7) in the area where it had to be installed, up to a maximum thickness of about 20 mm. Thanks to its softness and elasticity, the fiber layer (6) was able to adapt well to the very complex shape of the space between the support layer (4) and the SUV wheel arch housing component (7). During assembly on the SUV, it was found that each of the four wheel arch linings according to the invention is in contact with the wheel arch housing component (7) over at least about 85% of its surface area.

The serial wheel arch linings usually installed on SUVs are realized according to the specifications of the state of the art. In fact, they consist of a support layer to whose surface facing the wheel arch housing component two patches of noise-absorbing material are bonded. The support layer consists of a mixture of PP fibers (45% by weight) and PET fibers (55% by weight), it has a basis weight of about 1200 g/m² and a constant thickness of about 4 mm. Each absorbent patch consists of a layer of PET fibers wrapped with a thin nonwoven fabric. The basis weight of the absorbent patches is approximately constant over their surface area and is about 400 g/m². The overall thickness of the absorbent patches is constant and is about 10 mm. Furthermore, the absorbent patches have a rectangular shape and cover about 40% of the surface of the support layer facing the wheel arch housing component.

Due to their constant thickness and the fact that they cover only part of the surface of the support layer facing the wheel arch housing component, the absorbent patches do not adapt at all to the complex shape of this space and fill it only very partially. In the prior art wheel arch linings commonly installed on SUVs, there is no or no practically relevant contact between the absorbent patches and the wheel arch housing component. According to the state of the art, therefore, an air gap is left between the wheel arch lining and the wheel arch housing component over the entire surface of the wheel arch.

Acoustic tests were performed with the SUV in a semi-anechoic room equipped with a chassis dynamometer. Two different operating conditions were considered: constant speed at 50 km/h and acceleration from about 35 km/h to 95 km/h.

The noise in the passenger compartment was measured at the ear positions of the rear right front passenger. These positions were chosen because it is known that the rear seat positions are very critical with regard to tire noise. FIG. 3 shows the comparison between the mean value of the sound pressure levels measured at these two positions when the SUV is equipped with the standard prior art wheel arches (dotted line, marked “2”) and when the SUV is equipped with the wheel arches according to the invention (solid line, marked “1”). These data were measured at a constant speed of 50 km/h. As can be seen, the installation of the wheel arch linings according to the invention in the SUV achieves a significant reduction in the SPL spectrum, especially in the frequency range between 630 Hz and 1600 Hz, which is known to be the most relevant for tire noise.

The exterior noise was measured at 3 positions arranged as shown in FIG. 4 (the measurement positions are labeled M1, M2 and M3 in FIG. 4). These 3 positions are arranged along a line parallel to the longitudinal axis of the vehicle and at a distance of 7.5 m from this axis, which corresponds to the same distance at which the exterior noise must be measured according to the regulation ECE-R51.03 on exterior noise of motor vehicles currently in force in Europe.

The dashed line in FIG. 5 shows the mean value of the sound pressure levels measured at the 3 external microphones for the SUV equipped with the standard prior art wheel arch linings, during acceleration from about 35 km/h to about 95 km/h. The solid line (FIG. 5) shows the same magnitude for the SUV equipped with the wheel arch linings according to the invention. As can be seen, a reduction of almost 1 dB(A) is achieved over the entire speed range investigated.

These results show that the wheel arches according to the invention offer a significant reduction in internal and external noise compared to prior art solutions. This was achieved by recognizing that, contrary to what is usually assumed in the prior art, the existence of an air gap between the wheel arch lining (4, 5, 6) and the wheel arch housing component (7) can be detrimental to the acoustic performance of the part. By forming the fiber layer (6) in three dimensions in such a way that the space between the support layer (4) and the wheel arch housing component (7) is filled, a significant acoustic advantage can be achieved.

1. A wheel arch for a motor vehicle, with a wheel arch housing component for at least partially delimiting the wheel arch for a vehicle wheel of the motor vehicle, and with a wheel arch lining, which is arranged on the surface of the wheel arch housing component facing the wheel and extends at least partially along this surface, wherein the wheel arch lining comprises at least one support layer and one fiber layer, wherein the support layer forms the outer side of the wheel arch lining facing the wheel and the fiber layer being arranged between the wheel arch housing component and the support layer, and the support layer and the fiber layer being thermally bonded to one another and formed to a wheel arch lining and wherein at least 50%, is in contact with the wheel arch housing component.

2. The wheel arch liner of claim 1, wherein the fiber layer comprises a protective layer arranged on the surface of the fiber layer facing the wheel arch housing component.

3. The wheel arch liner of claim 1, wherein the wheel arch lining comprises a third layer arranged between the support layer and the fiber layer, which third layer is formed as a film with a weight per unit area of 5 to 200 g/m².

4. The wheel arch liner of claim 1, wherein the support layer and/or the fiber layer comprise sound-absorbing properties and the fiber layer, the optional third layer, and the support layer together have sound-insulating properties.

5. The wheel arch liner of claim 1, wherein the individual layers within the wheel arch lining comprise a variable thickness, density and/or weight per unit area.

6. The wheel arch liner of claim 1, wherein the fiber layer comprises a maximum thickness of 35 mm or less.

7. The wheel arch liner of claim 1, wherein the fiber layer in the finished component comprises a maximum thickness of 27 mm or less.

8. The wheel arch liner of claim 1, wherein the fiber layer in the finished component comprises a maximum thickness of 20 mm or less.

9. The wheel arch liner of claim 1, wherein the wheel arch lining is air-permeable, preferably with an air resistance of 500 to 6000 Rayls, preferably with an air resistance of 1500 to 4000 Rayls.

10. The wheel arch liner of claim 1, wherein the support layer is rigid and comprises a weight per unit area of 500 to 1400 g/m².

11. The wheel arch liner of claim 1, wherein the fiber layer comprises a basis weight of 400 to 1600 g/m².

12. The wheel arch liner of claim 1, wherein the third layer comprises a thermoplastic material, preferably a thermoplastic material based on a polyester, polyamide, polyurethane or polyolefin, further preferably based on a polypropylene, polyethylene or TPU.

13. The wheel arch liner of claim 1, wherein the fiber layer or the support layer comprises matrix fibers and binder fibers, wherein the matrix fibers are short fibers or continuous filaments, preferably based on a thermoplastic material, further preferably of synthetic, mineral or natural origin.

14. A motor vehicle comprising a wheel arch according to claim 1.

15. A method of manufacturing a wheel arch lining as defined in claim 1, the method comprising the steps of:
(a) providing a first fiber layer, a second layer provided as a support layer and, in particular, a third film layer arranged therebetween, in a forming tool; and
(b) single-stage thermal forming of the layers provided according to (a).

16. The method according to claim 15, wherein a third film layer is provided between the first fiber layer and the second layer, and the forming includes two substeps (b.1) and (b.2):
(b.1) exposure of the first fiber layer, the film layer and the second layer to water vapor through openings which are permeable to vapor and air and are arranged in the wall of the molding tool facing the first fiber layer, wherein the water vapor comprises a temperature and vapor wetness and a vapor pressure such that, on the one hand, the first fiber layer solidifies to form a material bond and, on the other hand, the vapor pressure of the water vapor against the third layer after passing through the fiber layer is sufficient to compress the second fiber layer;
(b.2) exposure of the second layer to water vapor through openings which are permeable to vapor and air and are arranged in the wall of the mold facing the second layer, wherein the water vapor comprises such a temperature and vapor wetness and such a vapor pressure that the second layer solidifies to form a material bond and the support layer is formed.

17. The method according to claim 16, wherein the third film layer becomes permeable to air by the steam exposure (b.1).

18. The method of claim 16, wherein the steam exposure takes place at a pressure of up to 15 bar.
